(19) United States
(12) Patent Application Publication
(10) Pub. No.: US 2004/0247010 A1
(43) Pub. Date: Dec. 9, 2004

(54) Antireflection diffraction grating

(76) Inventors: Makoto Okada, Osaka (JP); Kazuya Yamamoto, Osaka (JP)

Correspondence Address: Albert C Smith, Fenwick & West, 801 California Street, Mountain View, CA, 94041, US

(21) Appl. No.: 10/488,070

(22) PCT Filed: Oct. 7, 2003
(86) PCT No.: PCT/JP03/12836

(30) Foreign Application Priority Data
Oct. 7, 2002 (JP) 2002-293932

(51) Int. Cl. H01S 3/08

(52) U.S. Cl. 372/102

(57) ABSTRACT

The invention has been made to present a diffraction gating that has antireflection function for a broad band of lights and is easy to produce.

A diffraction grating according to the invention, is provided with projections of the grating (101) arranged with a certain period on a substrate. A monotonously decreases as z increases and the smaller z, the lager a decreasing rate of A for increase of z, is, where A is an area of the bottom of the projections and a cross-section parallel to the bottom and z is a distance between the bottom and the cross-section parallel to the bottom.

### TECHNICAL FIELD

The invention relates to a diffraction grating for antireflection, provided on a surface of optical elements including lenses. The invention relates particularly to a diffraction grating having antireflection function for broad-band lights.

### BACKGROUND ART

It is known that in optical systems having a plurality of optical elements such as camera lenses, intensity of light gradually decreases as the light passes through substrate materials, due to reflection loss on surfaces of the substrates so that intensity of the light at exit becomes smaller than intensity of the incident light. Accordingly, the more complicated an optical system, the less intensity of light is available for the system, so that performance of the system is deteriorated.

In order to prevent the above-mentioned deterioration of optical performance due to reflection loss, a method in which at least one kind of thin film layer with a high refractive index is (vapor-) deposited on a substrate of an optical element to prevent reflection of light on the surface, was developed at the beginning of twentieth century. The method is still widely used at present.

Generally a method for antireflection using thin film layer, has a dependence on wavelength, reflective index and thickness of the thin film layer. Accordingly, reflective index and thickness of the thin film layer are controlled for a specific wavelength to provide the thin film layer with antireflection function. Thus, in imaging and observing optical systems such as camera lenses, several tens or more of different thin film layers must be deposited for broad-band antireflection function. Control of thin film thickness by an apparatus for depositing thin films, requires higher accuracy for larger number of layers. As a result, manufacturing of such thin film layers is difficult.

A workaround to this problem of difficulty of control of thin film thickness, is use of a diffraction grating for antireflection. As shown in FIG. 1, a diffraction grating provided on an optical substrate 100 with projections of grating 101 arranged with a grating period Λ that is smaller than a wavelength in use, is produced. Such a diffraction grating has an antireflection effect similar to that of a thin film layer.

The reason is as below. Since a period of the diffraction grating is set below the wavelength in use, lights traveling as electromagnetic waves do not generate diffracted waves. Accordingly, diffractive effects caused by superposition of waves are not apparent. The diffraction grating can be regarded as an object having a different reflective index for traveling lights, and it has the same effect on electromagnetic waves as that of a material with an imaginary reflective index. As a result, the diffraction grating has the same effect as that of a thin film layer for a specific wavelength band, and it functions as an antireflection layer.

A method to regard a diffraction grating as a material having an imaginary reflective index, is called an effective index method. For example, the document “J. Turunen: Form-birefringence limits of Fourier-expansion methods in grating theory, Journal of Optical Society of America A Vol.13 No.5, page 1013” describes equations for obtaining an effective index from a shape of grating. FIG. 1 shows a shape of a diffraction grating and its approximated layer 110 having an effective reflective index. A value of the effective reflective index of the layer 110 is determined by a ratio of a height of projections of grating 101 to a period A of the diffraction grating.

Thus, antireflection function of a diffraction grating for antireflection depends on a wavelength in use, a period of a diffraction grating and a height of projections of the grating. Accordingly, a period of the diffraction grating and a height of projections of the grating are controlled in such a way that the diffraction grating has antireflection function for a specific wavelength. Projections of the grating can be made to be tapered toward the top so that an effective reflective index continuously changes in order to realize a broader wavelength band, as disclosed in “E. B. Grann et al.: Comparison between continuous and discrete subwavelength grating structures for antireflection surfaces, Journal of Optical Society of America A Vol.13 No.5, page 988”, “J. M. dos Santos et al.: Antireflection structures with use of multilevel subwavelength zero-order gratings, Applied Optics Vol.36 No.34, page 8935” and the like and shown in FIG. 2. A diffraction grating having projections tapered toward the top, has been proved to have antireflection function for a very broad wavelength band, like superposed multiple thin film layers having continuously changing thicknesses. Normal optical elements have a plane surface of a certain area. So, the above-mentioned tapered projections of the grating, arranged on the plane surface, have been proved to have antireflection function for polarization of incident lights.

In this situation, a molding die for molding plastic or glass diffraction gratings, in which a grating having tapered projections is produced, enables mass production of plastic or glass diffraction gratings having high antireflection function. A manufacturing method using a molding die, does not need a step of vapor-depositing thin films having higher reflective index. However, in the above-mentioned technique, size of each tapered projection of the grating is as small as a wavelength in use or less. Further, a ratio of a height h of projections of grating to a period Λ of the diffraction grating (an aspect ratio) must be one to several times as large as the period Λ. As a result, a standard molding die is difficult to produce, and a transfer ratio of a shape of a molded optical element, to a shape of the molding die is low. As a result, the diffraction grating does not perform antireflection function to a sufficient extent.

### DISCLOSURE OF INVENTION

As mentioned above, control of film thickness is difficult when depositing multiple layers of optical thin films for antireflection, to realize antireflection function for a broad band of lights. A diffraction grating with tapered projections and a high aspect ratio, having antireflection function for a broad band of lights, is difficult to produce in a step of producing a molding die and a step of transfer of a shape from the molding die to a product. Accordingly, there is a need for an optical element that has antireflection function for a broad band of lights and is easy to produce.

In the light of the situation mentioned above, the invention has been made to present a diffraction gating that has antireflection function for a broad band of lights and is easy to produce.

A diffraction grating according to the invention, is provided with projections of the grating arranged with a certain period on a substrate. A monotonously decreases as z increases and the smaller z, the lager a decreasing rate of A for increase of z, is, where A is an area of the bottom of the projections and a cross-section parallel to the bottom and z is a distance between the bottom and the cross-section parallel to the bottom.

A diffraction grating according to the invention, is provided with projections of the grating arranged with a certain period on a substrate. The projections are bell-shaped in at least one cross-section perpendicular to the substrate.

Thus, as to projections of the invented grating, the smaller a distance (z) from the bottom, the lager a decreasing rate of a cross-sectional area for increase of z, is. So, an effective index can change largely so that phase changes required for antireflection, can be realized even with lower grating heights. Accordingly, in the invented diffraction grating, a high transmittance can be realized without increasing height of the grating. For the gratings produced with molding dies, a high transmittance can be realized with a lower transfer ratio, so that requirements for a transfer ratio are relaxed, permitting easier production of the gratings.

According to an embodiment of the invention, the bottom of the projections and a cross-section parallel to the bottom are circular. Accordingly, the diffraction grating can be produced easily.

According to an embodiment of the invention, a shape of the projections of the grating has rotational symmetry around the axis that passes through the center of the bottom circle and is perpendicular to the bottom. Accordingly, the diffraction grating can be produced easily.

According to an embodiment of the invention, a period Λ of the diffraction grating satisfies the condition

$$0 < Λ < \frac{λ}{{n}^{′}} \qquad Inequality ( 1 )$$

where n′ is a reflective index of a material into which leaving light travels and λ is a wavelength in use. The condition mentioned above prevents generation of unnecessary diffracted lights.

According to an embodiment of the invention, the condition

$$0.6 < \frac{h}{Λ} \leq 1.5 \qquad Inequality ( 2 )$$

is satisfied where Λ is a period of the diffraction grating and h is a height of the projections, from the bottom.

The condition mentioned above determines a relationship between a grating period and a height of a diffraction grating that is good in antireflection function and easy to produce.

According to an embodiment of the invention, the substrate is made of a transparent material which lights having a wavelength in use, can pass through. As a result of this, no-reflection effect is realized for optical systems including cameras and glasses.

According to an embodiment of the invention, on the substrate, projections of the grating are arranged in such a way that centers of circles of the bottoms of the projections, are placed at apexes of squares having a side with a length equal to that of diameter of the circles of the bottoms.

According to an embodiment of the invention, on the substrate, projections of the grating are arranged in such a way that centers of circles of the bottoms of the projections, are placed at apexes of regular triangles having a side with a length equal to that of diameter of the circles of the bottom.

Such arrangements reduce plane areas on the substrate and thus cut reflection on the plane area to minimum.

According to an embodiment of the invention, the surface of the substrate on which the projections of the grating are arranged, is a plane one.

According to an embodiment of the invention, the surface of the substrate on which the projections of the grating are arranged, is a curved one.

According to an embodiment of the invention, the surface of the substrate on which the projections of the grating are arranged, is a stepped one.

Thus, in the embodiments of the invention, antireflection function can be realized independently of an aspect of a surface of the substrate.

### BRIEF DESCRIPTION OF DRAWINGS

FIG. 1 shows a shape of a diffraction grating and its approximated layer 110 having an effective reflective index;

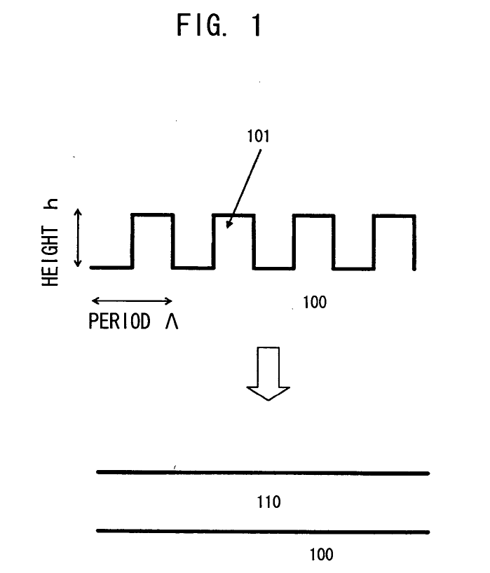

FIG. 2 shows a conventional diffraction grating provided with a cone-shaped projections;

FIG. 3 shows a cross-sectional view and a bottom view of projections of a diffraction grating according to the present invention;

FIG. 4 shows transmittances of a diffraction grating according to the invention, and those of a conventional diffraction grating, with various heights of the gratings;

FIG. 5 shows transmittances of a diffraction grating according to the invention, and those of a conventional diffraction grating, with (transfer) ratios in molding; and

FIG. 6 shows diffraction gratings according to the invention, arranged on a plane surface, a curved surface and a stepped surface.

### BEST MODE FOR CARRYING OUT THE INVENTION

Now an embodiment of a diffraction grating for antireflection according to the present invention, will be described. First, structural feature of a diffraction grating for antireflection according to the present invention, will be described and then functional feature thereof will be described.

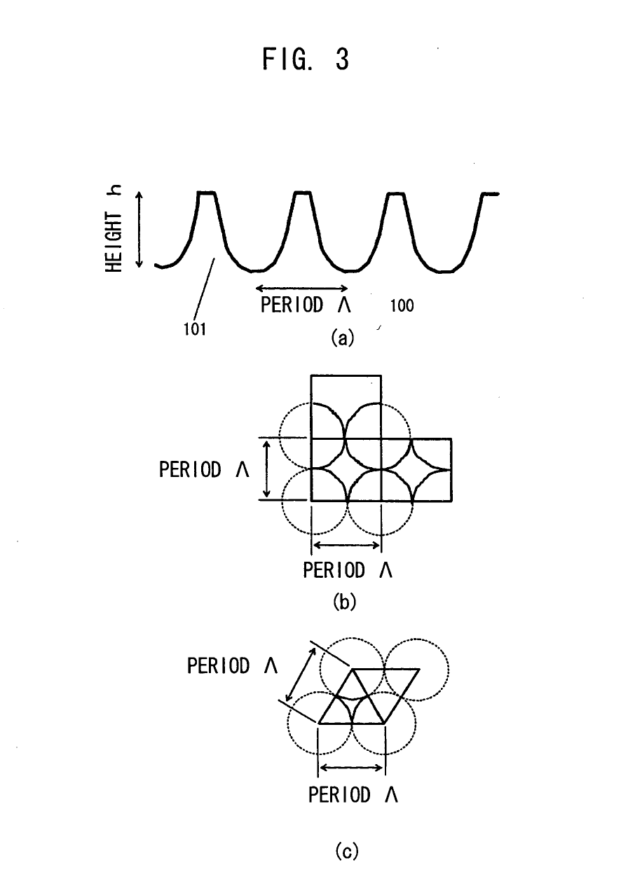

In the first place, a shape of projections of a diffraction grating for antireflection according to the present invention, will be described. FIG. 3(a) shows a cross-sectional view of projections of a diffraction grating for antireflection according to an embodiment of the present invention. A cross-sectional area of a projection of the diffraction grating monotonously decreases with height. Further, the lower the level, the more sharply the cross-sectional area decreases. That is, assuming that an area of the bottom and a cross-section parallel to the bottom is A and a distance between the bottom and the cross-section parallel to the bottom is z, A monotonously decreases as z increases. Further, the smaller z, the lager a decreasing rate of A for increase of z, is. Further, in the embodiment, a shape of a projection of the grating has rotational symmetry around the axis that passes through the center of the bottom circle and is perpendicular to the bottom.

A shape of a projection of the grating is not limited to the shape just described in the embodiment. The bottom and a cross-section parallel to the bottom may be an ellipse or a polygon. Further, the grating may be like channels arranged in a certain direction. In such cases, a projection of the grating is linear in the certain direction.

Next, a grating period of a diffraction grating for antireflection will be described. Assuming that a reflective index of a material into which leaving light travels is n′ and a wavelength in use is λ, a period Λ of the diffraction grating should preferably satisfy the following condition.

$$0 < Λ < \frac{λ}{{n}^{′}} \qquad Inequality ( 1 )$$

When the period of the diffraction grating exceeds the upper limit, diffracted lights of higher orders will appear. Due to effects of the diffracted lights besides those of reflected lights, intensity of light of 0^{th}-order decreases so that requirement for no reflection is not satisfied. The condition mentioned above prevents generation of unnecessary diffracted lights.

Further, a period Λ of the diffraction grating and a height h of the diffraction grating, should preferably meet the following condition.

$$0.6 < \frac{h}{Λ} \leq 1.5 \qquad Inequality ( 2 )$$

Inequality (2) shows limitations on a ratio of a height h to a period Λ of the diffraction grating (an aspect ratio). If the ratio is below the lower limit, requirement for no reflection for each wavelength, determined by a relationship between an effective reflective index and a height, is not satisfied. More specifically, due to a smaller aspect ratio, displacement of a phase for each wavelength is caused so that no-reflection feature is degraded as a whole. On the other hand, if the ratio is above the upper limit, a standard molding die and a molded product are difficult to produce though no-reflection feature is maintained. The inequality mentioned above determines a relationship between a period and a height of a diffraction grating that is good in antireflection feature and easy to produce.

Further, a diffraction grating for antireflection should preferably be provided with a substrate of a transparent material which lights having a wavelength in use, can pass through. As a result of this, no-reflection effect is realized for optical systems including cameras and glasses.

Now, an arrangement of projections of the grating, on a substrate will be described. FIG. 3(b) shows an arrangement of projections of a grating, on a substrate according to a preferable embodiment. On the substrate, projections of the grating are arranged in such a way that centers of circles of the bottoms of the projections, are placed at apexes of squares having a side with a length equal to that of diameter of the circles of the bottoms. Such arrangement reduces plane areas and thus cuts reflection on the plane area to minimum.

FIG. 3(c) shows an arrangement of projections of a grating, on a substrate according to another preferable embodiment. On the substrate, projections of the grating are arranged in such a way that centers of circles of the bottoms of the projections, are placed at apexes of regular triangles having a side with a length equal to that of diameter of the circles of the bottom. Such arrangement reduces plane areas and thus cuts reflection on the plane area to minimum.

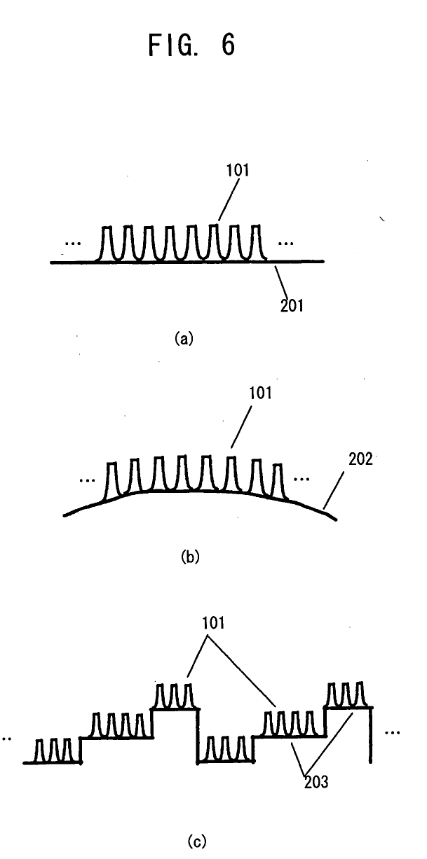

Now, an aspect of a surface of a substrate will be described. A diffraction grating for antireflection according to the invention, can be arranged on a plane surface, a curved surface, a stepped surface and the like of the substrate. FIG. 6(a) shows a diffraction grating for antireflection according to the invention, arranged on a plane surface 201. FIG. 6(b) shows a diffraction grating for antireflection according to the invention, arranged on a curved surface 202. FIG. 6(a) shows a diffraction grating for antireflection according to the invention, arranged on a stepped surface 203. A diffraction grating for antireflection according to the invention, performs antireflection function independently of an aspect of a surface of the substrate.

Structural features of a diffraction grating for antireflection according to the invention, has been described above. Now, functional features of a diffraction grating for antireflection according to the invention, will be described below.

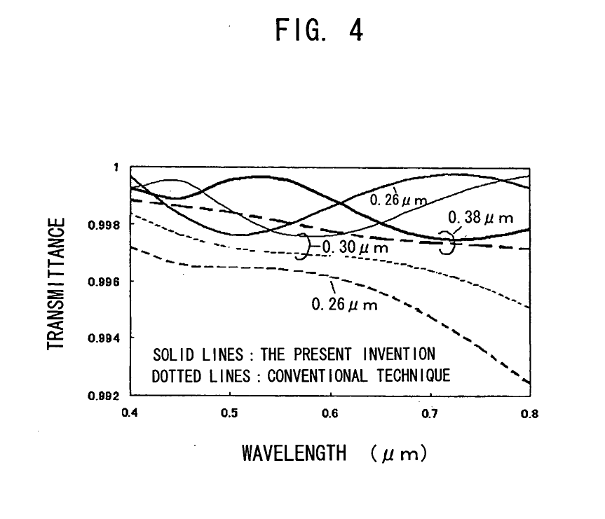

FIG. 4 shows 0^{th} order transmittances for incident light of a diffraction grating for antireflection according to the invention, and those of a conventional diffraction grating. The horizontal axis represents wavelength of incident light, while the vertical axis represents transmittance. The results have been calculated, assuming that a grating period is 0.36 μm and incident light is TE polarized and travels in a direction perpendicular to the substrate. The calculation has employed Rigorous Coupled Wave Analysis (RCWA) that rigorously reproduces behaviors of electromagnetic waves.

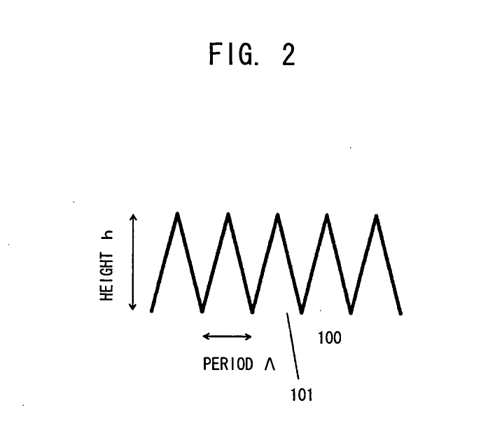

In the drawing dotted lines represent transmittances of a diffraction grating provided with conventional projections having a cone shape, a cross-sectional view of which is as shown in FIG. 2. Solid lines represent transmittances of a diffraction grating provided with projections a cross-sectional view of which is as shown in FIG. 3(a), according to an embodiment of the invention. Transmittances are given for grating heights of 0.26 μm, 0.30 μm and 0.38 μm, for both cases.

Transmittances of the conventional grating change more significantly than the invented grating as grating height changes. More specifically, for grating height of 0.38 μm, transmittance does not change so significantly as wavelength increases. However, for smaller grating heights, that is 0.30 μm and 0.26 μm, transmittances more significantly decrease as wavelength increases. On the other hand, transmittances of the invented grating do not change significantly for any grating height. Further, the invented grating has higher transmittances than the conventional grating, for all grating heights. More specifically, the invented grating has transmittances of 99.7% or more, for all grating heights. This means that the invented grating enables high transmittance without larger grating height.

The reason is as below. As to projections of the invented grating, the lower a level, the lager a decreasing rate of a cross-sectional area for increase of the level, is. So, an effective index can change largely so that phase changes required for antireflection, can be realized even with lower grating heights. Further, the invented grating has a smaller plane surface area that has a large influence on reflection of lights, thus reducing reflectance and increasing transmittance.

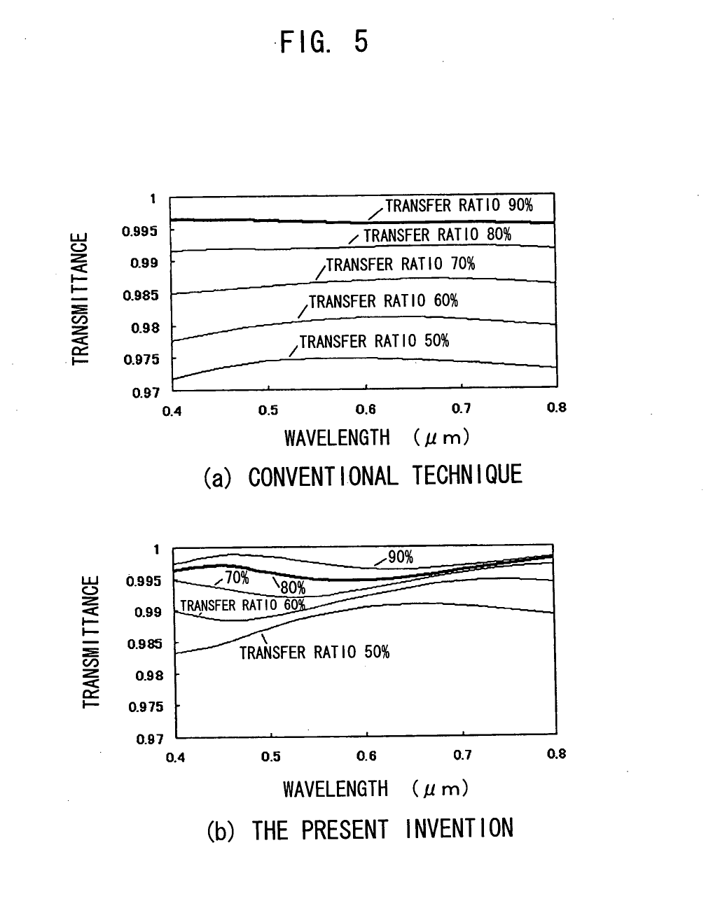

FIG. 5 shows change in transmittance against wavelength, for (transfer) ratios of a molded shape to a molding die shape. The horizontal axis represents wavelength and the vertical axis represents transmittance. A transfer ratio is more specifically a ratio of height of a molded projection of the grating, to height (depth) of a projection of the grating in the molding die. The higher a transfer ratio, the more closely the shape of the molded projection of the grating resembles the shape of the molding die. FIG. 5(a) shows the results of the conventional diffraction grating, while FIG. 5(b) shows the results of the diffraction grating according to an embodiment of the invention.

In the invented grating, transmittances are high enough for lower transfer ratios than in the conventional grating. This means easiness of molding. Provided that a transmittance of 99.5% or more is required, a transfer ratio must be 90% or more in the conventional grating, and 80% or more in the invented grating. The reason is as below. As to projections of the invented grating, the lower a level, the lager a decreasing rate of a cross-sectional area for increase of level, is. So, an effective index can change largely so that phase changes required for antireflection, can be realized even with lower grating heights.

In the embodiments mentioned above, it is assumed that incident light is TE polarized. The invented diffraction grating functions in a similar way with any polarization.

A substrate material of a diffraction grating according to the embodiments of the invention, may be any material that has a sufficient transmission in wavelength area in use. The material includes but is not limited to glass, plastic and optical crystal.

Further, a diffraction grating according to the embodiments of the invention, can be produced on any surface, independently of an aspect of a surface of the substrate, as shown in FIG. 6.

Further, the diffraction grating can be produced using lithography technique used in producing semiconductor (with light source of ultraviolet, x ray, electron beam or the like). On the other hand, a standard can be produced using the above-mentioned technique to produce a molding die. With the molding die, molding can be performed using plastic, glass or the like for mass-production.

1. A diffraction grating provided with projections of the grating arranged with a certain period on a substrate, wherein
A monotonously decreases as z increases and the smaller z, the lager a decreasing rate of A for increase of z, is, where A is an area of the bottom of the projections and a cross-section parallel to the bottom and z is a distance between the bottom and the cross-section parallel to the bottom.

2. A diffraction grating provided with projections of the grating arranged with a certain period on a substrate, wherein
the projections are bell-shaped in at least one cross-section perpendicular to the substrate.

3. A diffraction grating according to claim 1, wherein the bottom of the projections and a cross-section parallel to the bottom are circular.

4. A diffraction grating according to claim 3, wherein
a shape of the projections of the grating has rotational symmetry around the axis that passes through the center of the bottom circle and is perpendicular to the bottom.

5. A diffraction grating according to claim 1, wherein a period Λ of the diffraction grating satisfies the condition
$$0 < Λ < \frac{λ}{{n}^{′}}$$
where n′ is a reflective index of a material into which leaving light travels and λ is a wavelength in use.

6. A diffraction grating according to claim 1, wherein the condition
$$0.6 < \frac{h}{Λ} \leq 1.5$$
is satisfied where Λ is a period of the diffraction grating and h is a height of the projections, from the bottom.

7. A diffraction grating according to claim 1, wherein the substrate is made of a transparent material which lights having a wavelength in use, can pass through.

8. A diffraction grating according to claim 3, wherein on the substrate, projections of the grating are arranged in such a way that centers of circles of the bottoms of the projections, are placed at apexes of squares having a side with a length equal to that of diameter of the circles of the bottoms.

9. A diffraction grating according to claim 3, wherein on the substrate, projections of the grating are arranged in such a way that centers of circles of the bottoms of the projections, are placed at apexes of regular triangles having a side with a length equal to that of diameter of the circles of the bottom.

10. A diffraction grating according to claim 1, wherein the surface of the substrate on which the projections of the grating are arranged, is a plane one.

11. A diffraction grating according to claim 1, wherein the surface of the substrate on which the projections of the grating are arranged, is a curved one.

12. A diffraction grating according to claim 1, wherein the surface of the substrate on which the projections of the grating are arranged, is a stepped one.

13. A diffraction grating according to claim 1, produced through molding with a molding die.

14. A diffraction grating according to claim 13, wherein the lower a level of the grating, the lager a decreasing rate of the cross-section is, and an effective reflective index can change largely, so that decrease in transmittance ratio is minimized even if a height of the grating is smaller than a depth of the moulding die in transferring a shape of the moulding die to that of the grating.
